(19) United States
(12) Patent Application Publication
(10) Pub. No.: US 2011/0006972 A1
(43) Pub. Date: Jan. 13, 2011

(54) ORGANIC EL DISPLAY DEVICE

(75) Inventor: Masahiro TANAKA, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/830,528

(22) Filed: Jul. 6, 2010

(30) Foreign Application Priority Data
Jul. 7, 2009 (JP) 2009-160729

(51) Int. Cl. G09G 3/30

(52) U.S. Cl. 345/76

(57) ABSTRACT

A solid-sealing type organic EL display device is provided that can prevent water permeation through a defect generated in a passivation film which covers an extraction line in a peripheral sealing region thereby making it possible to prevent deterioration of an organic EL layer. An extraction line that couples a wiring line in a display region with a terminal part passes a peripheral sealing region. The extraction line is covered with an inorganic passivation film in the peripheral sealing region. The extraction line has a first flexure part and a second flexure part in the peripheral sealing region thereby making it possible to prevent a void and a crack generated in the inorganic passivation film from penetrating the peripheral sealing region. Consequently it is possible to prevent water permeation from outside and to prevent the deterioration of the organic EL layer.

### CLAIM OF PRIORITY

The present application claims priority from Japanese Patent Application JP 2009-160729 filed on Jul. 7, 2009, the content of which is hereby incorporated by reference into this application.

### BACKGROUND OF THE INVENTION

1. Technical Field

The present invention relates to an organic electro-luminescence (EL) display device, particularly a highly reliable organic EL display device in which appearance of dark areas due to water is prevented.

2. Related Art

In an organic EL display device, an organic EL layer is interposed between a lower electrode and an upper electrode. Luminescence of the organic EL layer is controlled by applying a fixed voltage to the upper electrode and applying a data signal voltage to the lower electrode. The data signal voltage is supplied to the lower electrode through a thin film transistor (TFT). The organic EL layer emits red, green or blue light depending on a material of an emissive layer. A pixel including such organic EL layer and the TFT is arranged in matrix and an image is formed by controlling luminescence of each pixel.

There are two types of the organic EL display device, one is a bottom-emission type in which light from the organic EL layer is emitted toward a glass substrate on which the organic EL layer and the like is formed, and the other is a top-emission type in which light is emitted toward the opposite side that is remote from the glass substrate where the organic EL layer and the like is formed. The top-emission type has an advantage that an emission region can be formed over an area where the TFT is formed.

Luminescence properties are deteriorated when water exists in an organic EL material of the organic EL display device, and the area where the luminescence properties are deteriorated due to water will stop emitting light eventually while the device is operated for a long period of time. Such area appears as a dark spot in a display region. The dark spot grows as time advances and results in an image defect. Image signal lines, scan lines and the like pass through a peripheral sealing region and are coupled to terminals via extraction lines. A part of the peripheral sealing region where the terminals pass is prone to water, and the so-called dark area which does not emit light often arise around such part.

In order to prevent the dark area and the like from being generated or grown, it is necessary to stop water seeping into an organic EL display device or to remove water intruded in the device. Conventionally, an element substrate on which the organic EL layer is formed is sealed by a sealing substrate with a sealant which is arranged along the peripheral of the element substrate. This is one of the techniques developed to prevent water from coming inside the organic EL display device. A sealed space is filled with an inactive gas such as N₂. At the same time, desiccant is provided inside the organic EL display device in order to remove the water that is penetrated in the organic EL display device. Such organic EL display device is referred as to a hollow-sealing type organic EL display device.

However, the hollow-sealing type organic EL display device has disadvantages that adjustment of a gap between the element substrate and the sealing substrate is difficult, the sealant which adhesively bonds the element substrate with the sealing substrate at their peripheral must have a large width in order to prevent water from intruding inside, an organic EL material can be contaminated with a gas emitted from the sealant when the substrate is sealed with the sealant, throughput is low and so forth. Moreover, another disadvantage in a completed EL display device is that the organic EL layer can be damaged when the element substrate and the sealing substrate contact each other by an external force applied to the element substrate or the sealing substrate.

JP-A-2007-156058 is an example of the related art. In order to solve the above-mentioned problem of the hollow sealing, the example discloses a technique in which an inorganic passivation film, an organic planarizing film and another inorganic passivation film are formed on the organic EL display panel where the organic EL layer and the upper electrode are provided without using a sealing substrate. Such sealing structure is hereinafter referred as to solid sealing.

Highly reactive metal such as an alkali metal and an alkaline-earth metal is generally used for an electron-injection layer of the organic EL layer. When water exists in the layer, such metal reacts with water and deactivation occurs and therefore it is necessary to conduct sealing in such a way that water intrusion is prevented. The structure in which the inorganic passivation film, the organic planarizing film and the inorganic passivation film are formed over the organic EL display panel having the upper electrode has a possibility to realize a relatively robust, thin and low-cost organic EL display device. As used herein, this sealing method is referred as to the solid sealing.

A display region where an organic EL layer is formed is surrounded by a peripheral sealing region. In the peripheral sealing region, an organic film such as the organic planarizing film is not formed but only an inorganic film such as the inorganic passivation film is used for sealing in order to prevent water from penetrating from outside. This is because organic films have water permeability.

However, even when the peripheral sealing region is formed of an inorganic film alone, if a defect such as void exists in the inorganic film, water enters through the defect into a display region where is close to a terminal region and resulting in a dark area. The inorganic passivation film and the like are fabricated through a low-temperature chemical vapor deposition (CVD) such as a plasma CVD, and it is difficult to eliminate defects such as voids completely.

### SUMMARY OF THE INVENTION

The present invention has an object to realize an organic EL display device with a fine product-life property and in which water intrusion from outside to a peripheral sealing region is prevented even when a void is generated in an inorganic passivation film or the like since the void penetration into the peripheral sealing region is hampered.

In view of the above problems in the conventional art, the invention has the following features to solve the problems.

According to a first aspect of the invention, an organic electro-luminescence (EL) display device includes a pixel having an organic EL layer that is disposed between a lower electrode and an upper electrode, and a thin film transistor (TFT), the pixel being arranged in matrix; a display region in which a wiring line coupled to the pixel is formed; a peripheral sealing region provided in a periphery of the display region; a terminal part; and an extraction line coupling the wiring line and the terminal part. The extraction line is directly covered with an inorganic film in the peripheral sealing region, and the extraction line has two flexure parts in the peripheral sealing region.

It is preferable that the flexure parts be bent at 90 to 150 degrees.

It is more preferable that the flexure parts be bent at 90 to 120 degrees.

It is preferable that the flexure parts be bent at 90 degrees.

According to a second aspect of the invention, an organic EL display device includes a pixel having an organic EL layer that is disposed between a lower electrode and an upper electrode, and a TFT, the pixel being arranged in matrix; a display region in which a wiring line coupled to the pixel is formed; a peripheral sealing region provided in a periphery of the display region; a terminal part; and an extraction line coupling the wiring line and the terminal part. The extraction line is directly covered with an inorganic film in the peripheral sealing region, the extraction line has a first flexure part and a second flexure part in the peripheral sealing region, and an angle of the first flexure part is different from an angle of the second flexure part.

According to a third aspect of the invention, an organic EL display device includes a pixel having an organic EL layer that is disposed between a lower electrode and an upper electrode, and a TFT, the pixel being arranged in matrix; a display region in which a plurality of wiring lines coupled to a plurality of the pixels are formed; a peripheral sealing region provided in a periphery of the display region; a plurality of terminal parts; and a plurality of extraction lines coupling the plurality of the wiring lines and the plurality of the terminal parts. The plurality of the extraction lines are directly covered with an inorganic film in the peripheral sealing region, each of the extraction lines has two flexure parts in the peripheral sealing region, and angles of the flexure parts of the plurality of the extraction lines are different from each other.

According to a forth aspect of the invention, an organic EL display device includes a pixel having an organic EL layer that is disposed between a lower electrode and an upper electrode, and a TFT, the pixel being arranged in matrix; a display region in which a wiring line coupled to the pixel is formed; a peripheral sealing region provided in a periphery of the display region; a terminal part; and an extraction line coupling the wiring line and the terminal part. The peripheral sealing region has a first side that is adjacent to an area where the terminal part is formed, and a second side, a width of the first side being larger than a width of the second side, the extraction line is directly covered with an inorganic film on the first side of the peripheral sealing region, and the extraction line has two flexure parts on the first side of the peripheral sealing region.

It is preferable that the width of the first side of the peripheral sealing region be ten times or more larger than the width of the second side of the peripheral sealing region.

According to the aspects of the invention, in the solid-sealing type organic EL display device, it is possible to prevent voids or cracks from being generated in the inorganic passivation film formed over the extraction line in the peripheral sealing region around the display region. Consequently it is possible to prevent the organic EL layer from being deteriorated by water and the appearance of the dark area can be prevented in the organic EL display device.

### BRIEF DESCRIPTION OF THE DRAWINGS

FIG. 1 is a sectional view of an organic EL display device according to the present invention;

FIG. 2 is a perspective view of an organic EL display panel in which a dark area appears;

FIG. 3 shows a configuration of an extraction line in a peripheral sealing region, to which the invention is not applied;

FIG. 4 shows a configuration of an extraction line in the peripheral sealing region according to a first embodiment of the invention;

FIG. 5 is an explanatory drawing of the extraction line in the peripheral sealing region according to the first embodiment;

FIG. 6 is a perspective view of the extraction line in the peripheral sealing region according to the first embodiment;

FIG. 7 is a sectional view along the A plane in FIG. 6;

FIG. 8 is a sectional view along the B plane in FIG. 6;

FIG. 9 is a perspective view of an organic EL display device according to the first embodiment;

FIG. 10 is an explanatory drawing of an extraction line according to a second embodiment showing its configuration; and

FIG. 11 illustrates a configuration of the extraction line in the peripheral sealing region according to the second embodiment.

### DESCRIPTION OF EXEMPLARY EMBODIMENTS

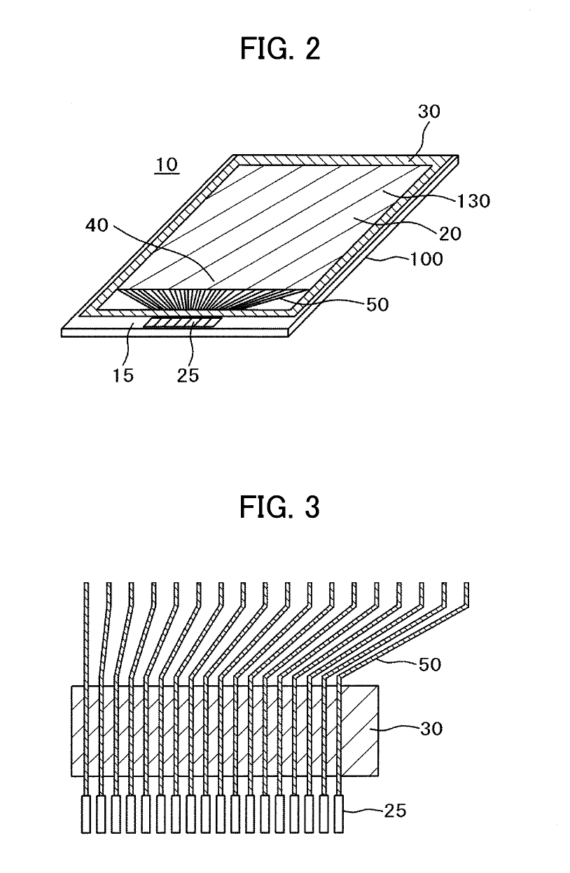

Before providing a description of specific structures of the invention, an organic electro-luminescence (EL) display device of a solid sealing type to which the invention is applied will be firstly described. FIG. 2 is a perspective view of an organic EL display device 10 to which the invention is applied, showing the state where a dark area 40 appears in an area of a display region 20 near a terminal region. Referring to FIG. 2, the display region 20 and a terminal region 15 are formed on an element substrate 100 which is made of glass. The display region 20 is covered with an organic planarizing film 130, and the organic planarizing film 130 is situated at substantially the same position as a position where the display region 20 is situated. The organic planarizing film 130 is not provided in the periphery of the display region 20 but a peripheral sealing region 30 which is covered with an inorganic passivation film is formed. An organic film is water-permeable so that the organic planarizing film 130 is not provided from the peripheral sealing region 30.

The terminal region 15 is formed outside the display region 20. An extraction line 50 of a scan line, a signal line, a power line and the like is extended to the terminal region 15 and then coupled to a terminal part 25 in the terminal region 15. A scan signal, an image signal, electric current and the like are supplied through the terminal part 25.

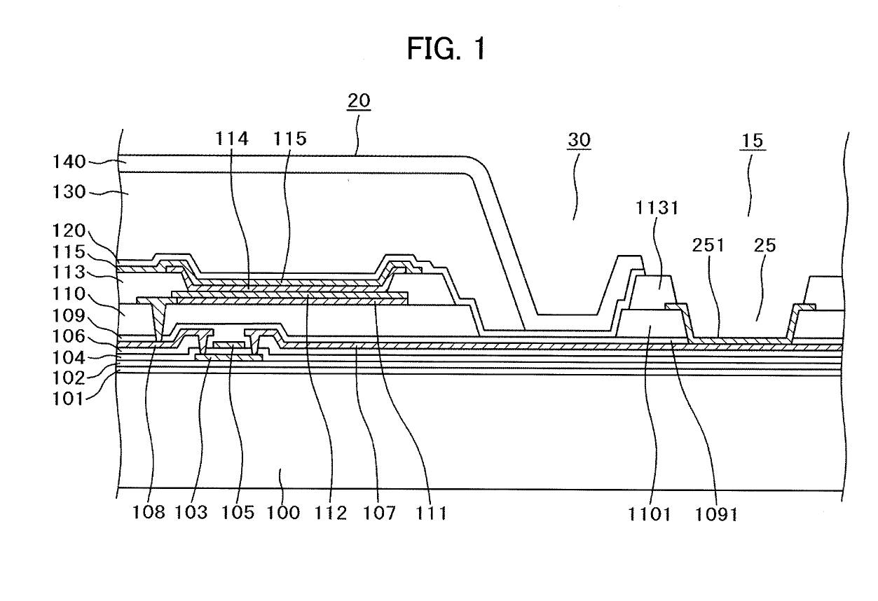

FIG. 1 is a sectional view of the device schematically showing a structure according to the invention. FIG. 1 illustrates a part of the display region 20, the peripheral sealing region 30 and a cross-section of the terminal region 15. In the following description, the organic EL display device 10 is described as the top-emission type. However, the invention is not limited to this but can also be applied to the bottom-emission type organic EL display device.

Referring to FIG. 1, in the display region 20, a first base film 101 made of SiN is formed on the element substrate 100 which is made of glass, and a second base film 102 made of SiO₂ is provided on the first base film. The first base film 101 and the second base film 102 are provided in order to prevent properties of a semiconductor layer 103 from being deteriorated due to contamination of impurities that are separated from the glass substrate.

The semiconductor layer 103 is provided on the second base film 102. In this embodiment, the semiconductor layer 103 is formed of poly-Si and has a thickness of about 50 nm. To form the poly-Si semiconductor layer 103, an a-Si layer is firstly formed, the a-Si layer is then annealed by using an excimer laser and the like in order to transform the layer into a poly-Si layer.

A gate electrode 105 is provided on the semiconductor layer 103. The gate electrode 105 is formed in the same layer as that of a gate wiring line. In the semiconductor layer 103, a channel part, a source region and a drain region are provided. The source region and the drain region are formed by adding impurities into the semiconductor layer 103 through ion implantation which utilizes the gate electrode 105 as a mask.

An interlayer insulation film 106 is formed of SiN or the like so as to over the gate electrode 105. A source wiring line 108 and a drain wiring line 107 are formed on the interlayer insulation film 106. In this embodiment, the drain wiring line 107 also serves as an image signal line. Since electric current which is used to make an organic EL layer 114 produce luminescence runs through the source wiring line 108 and the drain wiring line 107, these wiring lines are made of Al which is a low-resistance metal and have a relatively large thickness of about 700 nm. Under the Al wiring line, a barrier metal 1071 which is made of a high-melting-point metal such as Mo and Ti is provided to prevent semiconductors and the like from being contaminated by Al. Over the Al wiring line, a cap metal 1072 which is made of a high-melting-point metal such as Mo and Ti is provided to prevent hillock of Al.

The source wiring line 108 and the drain wiring line 107 are coupled with the source region and the drain region of the semiconductor layer 103 respectively via through-holes which are formed in a gate insulation film 104 and the interlayer insulation film 106. The drain wiring line 107 passes the peripheral sealing region 30 and extends to the terminal part 25. The source wiring line 108 is coupled to a lower electrode 112 of the organic EL layer 114.

A first inorganic passivation film 109 is formed of SiN or the like so as to cover the source wiring line 108 and the drain wiring line 107. A main role of the first inorganic passivation film is to protect the TFT from outside impurities. An organic passivation film 110 is formed on the first inorganic passivation film 109. A role of the organic passivation film is to protect the TFT and to planarize the surface. With the film, the organic EL layer 114 can be formed on a flat surface and it is possible to prevent the organic EL layer 114 from breaking off.

A reflective film 111 made of a high-reflectivity metal such as Al and Ag is provided on the organic passivation film 110. In this embodiment, the organic EL display device 10 is the top-emission type so that light emitted from the organic EL layer 114 is reflected toward the upper side in FIG. 1 by the reflective film 111 with which a light use efficiency is enhanced.

On the reflective film 111, the lower electrode 112 which is made of a transparent conductive film, indium tin oxide (ITO), and serves as an anode for the organic EL layer 114 is deposited. The ITO that serves as the lower electrode 112 is coupled to the source wiring line 108 through a through-hole which is formed in the first inorganic passivation film 109 and the organic passivation film 110.

On the lower electrode 112, the organic EL layer 114 is formed. The organic EL layer 114 generally includes more than one layer. For example, naming from the anode side, the EL layer includes a hole injection layer having a thickness of 50 nm, a hole transport layer having a thickness of 50 nm, an emissive layer having a thickness of 20 nm, an electron transport layer having a thickness of 20 nm, an electron injection layer having a thickness of 1 nm and the like. Each layer is very thin and even the thickness of all the above-mentioned five layers is only amounted to about 140 nm.

A bank 113 that defines each pixel and is made of an acrylic resin is formed on the lower electrode 112 and the organic passivation film 110. As described above, each layer included in the organic EL layer 114 is very thin so that the layer can be broken off at portions having bump or difference in level. The bank 113 has a role to prevent such breakage particularly at end portions of the organic EL layer 114.

An upper electrode 115 which is made of a transparent conductive film, indium zinc oxide (InZnO), and serves as a cathode is provided on the organic EL layer 114. Both the InZnO and ITO are transparent conductive films but the InZnO has a lower resistance before annealing is conducted. Annealing cannot be performed after the organic EL layer 114 is deposited since the organic EL layer 114 is weak against heat, therefore the InZnO is used for the cathode.

Through the above-described steps, the typical organic EL display device 10 of the element substrate 100 side is completed. The invention is applied to the solid sealing type so that the upper electrode 115 is covered with a second inorganic passivation film 120 that is made of SiN or the like in order to protect the organic EL layer 114 from water. The second inorganic passivation film 120 has a thickness of about 200 nm.

The second inorganic passivation film 120 is further covered with the organic planarizing film 130. The organic planarizing film 130 can be formed of an epoxy resin, thermoplastic polypropylene and polyethylene and the like. The organic planarizing film 130 is provided in a relatively large thickness of about 30 μm, therefore it is formed by printing, film transfer printing or the like. The thickness of the organic planarizing film 130 can be adjusted about from 10 to 100 μm depending on specifications of the organic EL display device product.

A third inorganic passivation film 140 is formed on the organic planarizing film 130. The third inorganic passivation film 140 is formed by depositing SiN in about 1 μm thick through a low temperature CVD such as a plasma CVD and a pyrolytic CVD using a tungsten wire as catalyst. Water from outside is blocked mainly by the third inorganic passivation film 140. The third inorganic passivation film 140 is blanket-deposited except the area of the terminal part 25. The third inorganic passivation film 140 is removed from the terminal part 25 by photolithography or the like.

Referring to FIG. 1, the drain wiring line 107 that is coupled to the terminal runs through the peripheral sealing region 30. The second base film 102, the gate insulation film 104 and the interlayer insulation film 106 are situated under the drain wiring line 107, the first base film 101. The first inorganic passivation film 109, the second inorganic passivation film 120 and the third inorganic passivation film 140 are situated over the drain wiring line 107. In other words, the peripheral sealing region 30 is sealed only with inorganic films since organic films are water permeable.

Referring to FIG. 1, the drain wiring line 107 extends to the terminal region 15 and an image signal is provided from the terminal part 25. The drain wiring line 107 is manly made of Al and it is coated with a terminal-part conductive film 251 which is formed of ITO in the area of the terminal part 25 since it is susceptible to corrosion due to an external environment. The ITO used for the terminal-part conductive film 251 is the same layer as the one forming the lower electrode 112.

The drain wiring line 107 that is extended and situated in the terminal region 15 is covered with a protection film 1091 that is made of the same layer as the first inorganic passivation 109, a protection film 1101 that is made of the same layer as the organic passivation film 110 and a protection film 1131 that is made of the same layer as the bank 113, and thereby the wiring line is protected from the outside air.

FIG. 3 is a plan view of the organic EL display device 10 shown in FIG. 2 around the terminal region 15 showing the peripheral sealing region 30 and a configuration of the extraction line 50. Referring to FIG. 3, the extraction line 50 linearly passes through the peripheral sealing region 30. In the peripheral sealing region 30, the extraction line 50 is covered with the first inorganic passivation 109, the second inorganic passivation film 120 and the third inorganic passivation film 140 as illustrated by FIG. 1.

Referring to FIG. 3, the first inorganic passivation film 109 contacts with the extraction line 150, and therefore the first inorganic passivation film 109 is likely to have defects such as a void. When a defect is generated, it often extends sequentially along the extraction line 50 which is linearly formed under the peripheral sealing region 30. In the case where the defect penetrates the peripheral sealing region 30, water passes through the peripheral sealing region 30 and reaches the inside of the organic EL display device 10, which deteriorates the organic EL layer, and resulting in the dark area 40.

The invention prevents such defect in the peripheral sealing region 30 and realizes a feature with which it is possible to prevent water from passing through the peripheral sealing region 30. The invention will be described in detail in the hereunder embodiments.

### First Embodiment

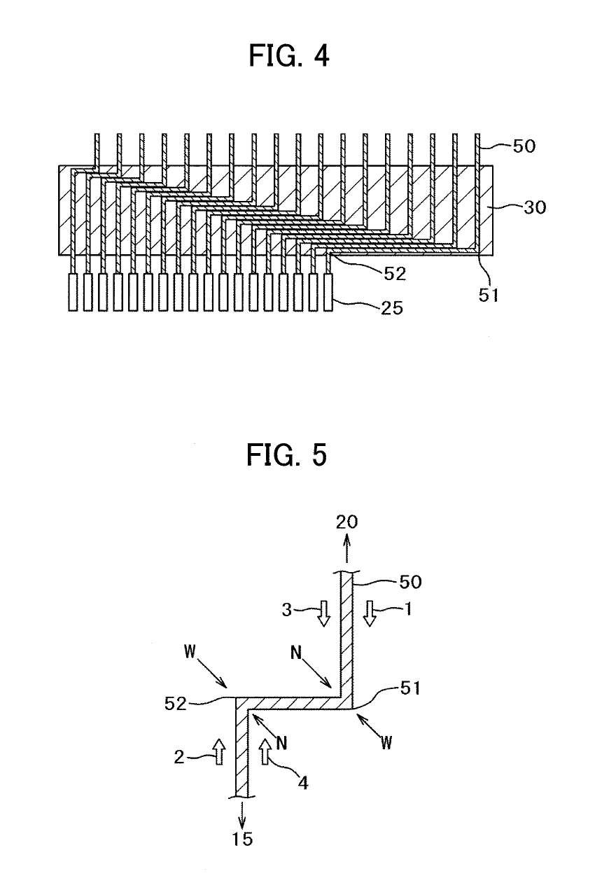

FIG. 4 is a plan view showing a configuration of the extraction line 50 in the peripheral sealing region 30 according to a first embodiment of the invention. Referring to FIG. 4, the extraction line 50 here is, for example, an extraction line of the image signal line. In the structure illustrated in FIG. 4, a pitch of the terminal is smaller than a pitch of the image signal line in the display region 20. In FIG. 4, the extraction line 50 extended from the display region 20 bends twice, at a first flexure part 51 and at a second flexure part 52.

The inorganic passivation film is formed by depositing SiN in a requisite amount through a low-temperature chemical vapor deposition (CVD) such as a plasma CVD and a pyrolytic CVD using a tungsten wire as catalyst. In this step, a large amount of the inorganic passivation films are fabricated in a short time period in order to improve the throughput, therefore it is prone to defect such as void. An example of a void 60 is illustrated in FIG. 7.

When the inorganic passivation film that is fabricated by the low-temperature CVD as described above, the void 60 is not generated on the W side of the first flexure part 51 or the second flexure part 52, which is illustrated in FIG. 5. This is because the W side has a wider space compared to that of the N side so that active molecules can reach the wiring part without being obstructed during the vapor deposition.

Referring to FIG. 5, even when the void 60 that is generated from the display region 20 side in the inorganic passivation film moves along the extraction line 50 in the direction pointed by the arrow 1, the void 60 is dissipated at the W side of the first flexure part 51. The void 60 that moves along the extraction line 50 from the terminal region 15 to the direction pointed by the arrow 2 is dissipated at the W side of the second flexure part 52.

In the same manner, the void 60 that moves along the extraction line 50 from the display region 20 to the direction pointed by the arrow 3 is dispelled at the W side of the second flexure part 52. The void 60 that moves along the extraction line 50 from the terminal region 15 side to the direction pointed by the arrow 4 is dispelled at the W side of the first flexure part 51. In this way, the void 60 generated in the inorganic passivation film can be securely dissipated by providing the two flexure parts of the extraction line 50 in the peripheral sealing region 30.

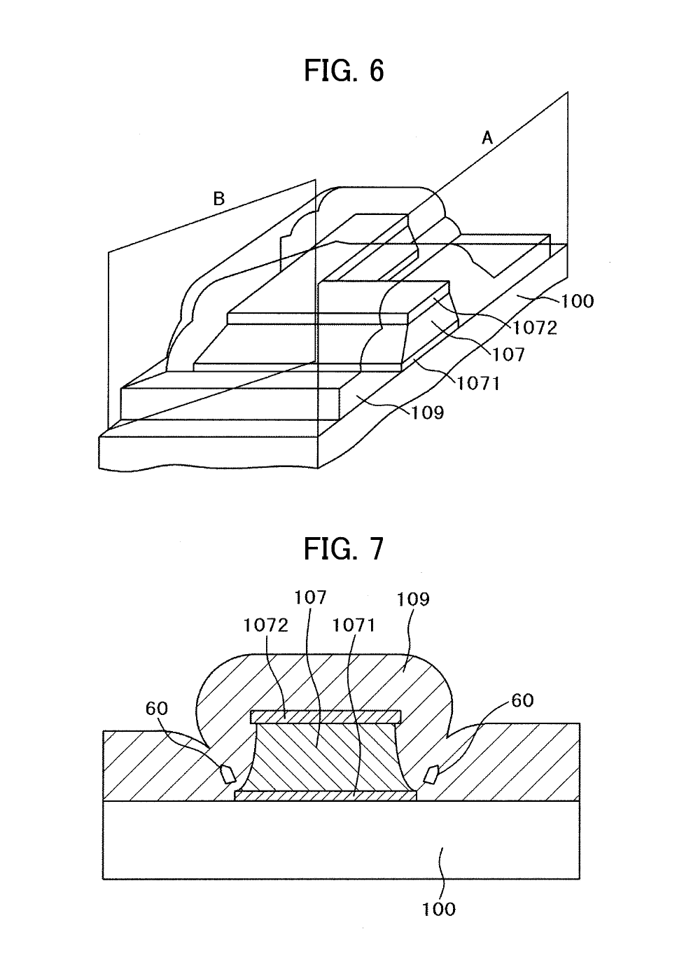

FIGS. 6 and 7 are illustrated for further describing the details of the above mentioned feature. FIG. 6 is a perspective view of the structure in which the inorganic passivation film is fabricated on the extraction line 50 that is formed on the substrate. The extraction line 50 is formed in the same layer and has the same structure as the image signal line. In an actual product, though the image signal line and the extraction line 50 are formed on an interlayer insulation film, the film structure below the interlayer insulation film is not illustrated in FIGS. 6 and 7. Referring to FIG. 7, the image signal line and the extraction line 50 are made of Al. Under the Al, the barrier metal 1071 which is made of a high-melting-point metal such as Mo and Ti is provided. Over the Al, the cap metal 1072 which is made of a high-melting-point metal such as Mo and Ti is provided. The image signal line and the extraction line 50 are covered with the first inorganic passivation film 109 which is formed of SiN by CVD.

FIG. 7 is a sectional view of the linear part along the cross-section A shown in FIG. 6. Referring to FIG. 7, the voids 60 are generated at the both sides of the wiring line. The voids 60 stretch along the wiring line. Most of the voids 60 are buried and dissipated by SiN but some can penetrate the passivation film. When the void 60 penetrates, water passes through that part and the organic EL layer is deteriorated. Moreover, a crack can be developed in the inorganic passivation film along the void 60. In this case, water penetrates along the crack and the dark area 40 can be generated.

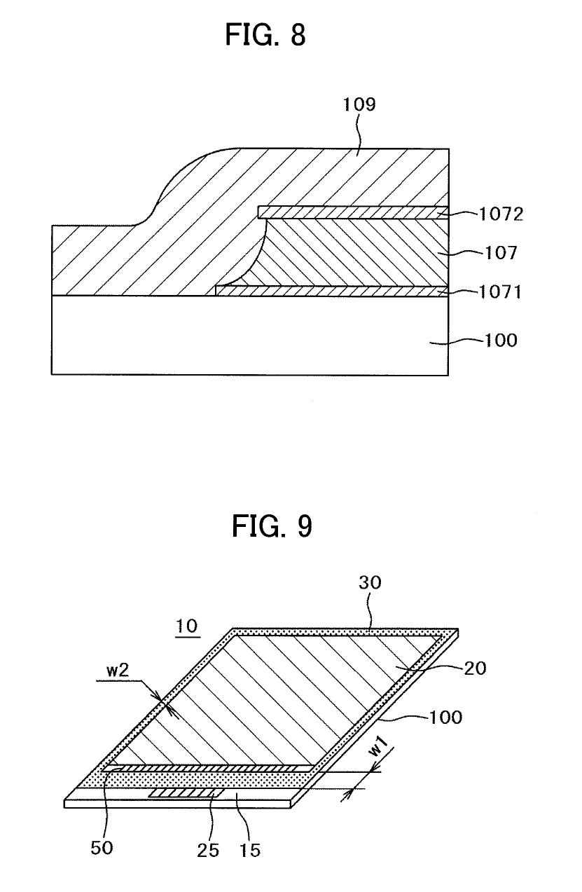

FIG. 8 is a sectional view along the B cross-section in FIG. 6, showing a sectional view of a part of the extraction line 50 which is cranked. Referring to FIG. 8, the outside of the flexure part which is bent in the cranked shape is wide open so that active molecules are not obstructed during CVD, a CVD film sufficiently grows and consequently the void 60 is dissipated. Even when a crack is developed in the inorganic passivation film along the void 60, the crack development is stopped at the flexure part.

Though FIGS. 6 to 8 illustrate the case in which the extraction line 50 is bent in the right side, even with the case in which the line is bent in the left side, it is possible to prevent the void 60 from further spreading and to prevent the crack due to the void 60 from being further developed at the wide open side of the flexure part. In other words, the extraction line 50 has the two flexure parts in the peripheral sealing region 30, thereby it is possible to securely prevent the void 60 and the crack from further stretching.

As described above, a sealing width w1 becomes large when the extraction line 50 is bent twice in the peripheral sealing region 30. However, this part of the peripheral sealing region 30 is situated adjacent to the terminal region 15 so that it is possible to secure a relatively large width. Meanwhile, the other parts of the peripheral sealing region 30 at the other sides cannot have large widths since there is demand for a smaller sized frame. FIG. 9 is a perspective view of the organic EL display device 10 to which the invention is applied.

Referring to FIG. 9, the peripheral sealing region 30 is formed in the periphery of the display region 20. The extraction line 50 extends from the display region 20 toward the terminal region 15. The extraction line 50 is bent in a crank shape below the area of the peripheral sealing region 30 with a large width such as w1, and the line is coupled with the terminal part 25.

Referring to FIG. 9, the peripheral sealing region 30 that covers the part of the extraction line 50 where is bent in the crank shape has a relatively large width, for example, the width w1 can be about 3 mm. Meanwhile, the width w2 of the peripheral sealing region 30 at the other side of the organic EL display 10 is about 50 μm in order to meet the demand for a smaller frame.

In this case, the width w1 of the peripheral sealing region 30 where the extraction line 50 passes through is 60 times larger than the width w2 of the peripheral sealing region 30 on the other side. It is generally possible to make the frame area around the display region 20 smaller and to secure the reliability of the sealing in the area of the extraction line 50 by setting the width w1 of the peripheral sealing region 30 where the extraction line 50 passes through 10 times or more larger than the width w2 of the peripheral sealing region 30 on the other side.

### Second Embodiment

In the first embodiment, the extraction line 50 is bent at 90 degrees in the crank shape in the peripheral sealing region 30. However, the extraction line 50 is not necessarily bent at 90 degrees in order to prevent the void 60 from stretching in the inorganic passivation film and to prevent the crack from further developing in the inorganic passivation film.

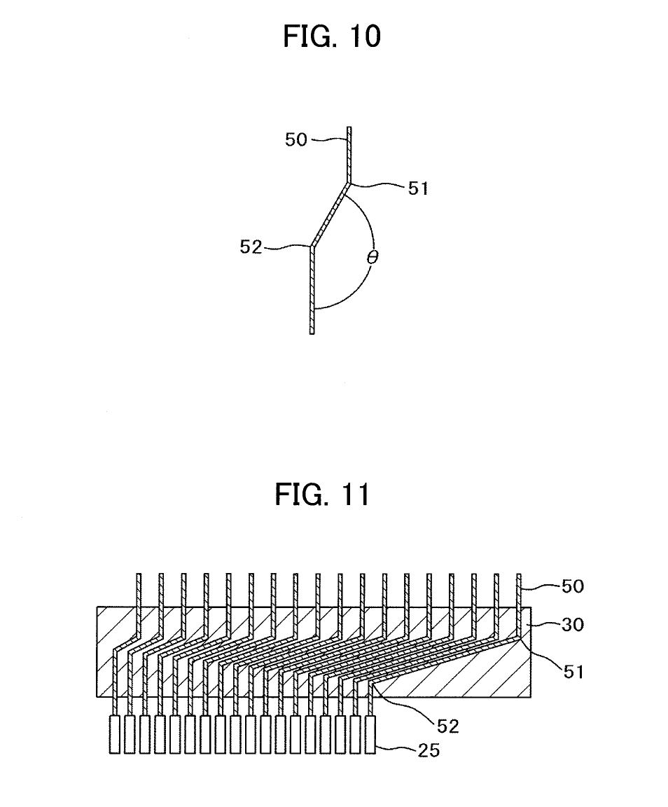

FIG. 10 illustrates an example in which a single extraction line 50 is bent at an angle larger than 90 degrees. In other words, the angle θ shown in FIG. 10 is 90 degrees according to the first embodiment but the angle is larger than 90 degrees according to the second embodiment. Even in this case, the wide open parts at the first flexure part 51 and the second flexure part 52, in other words, the sides of the flexure parts at the angle (360−θ), can hamper the progress of the void 60 and the crack from the peripheral sealing region 30 along the extraction line 50.

According to the experiments, the flexure part has the above-mentioned advantages effect when the angle θ is set about 90 to 150 degrees. It is preferable that the angle be set from 90 to 120 degrees, and more preferably from 90 to 100 degrees. Though the first flexure part 51 and the second flexure part 52 have the same angle in FIG. 10, they do not necessarily have the same angle in the actual product but the angles may be different between the first flexure part 51 and the second flexure part 52 in consideration of the arrangement of the extraction line 50.

FIG. 11 illustrates an example in which the extraction line 50 shown in FIG. 10 is applied to an actual product. In FIG. 11, each extraction line 50 has two flexure parts. The flexure angles of each extraction line 50 are not necessarily identical but can be different depending on the position where the extraction line 50 is arranged.

As illustrated in FIG. 11, the flexure angles, in other words, the angles θ shown in FIG. 10, of the extraction lines 50 that are situated close to the periphery tend to get smaller than the flexure angles of the extraction lines 50 that are situated around the center of the row of the terminals. In this case, the extraction lines 50 that are situated close to the periphery can exert the above-mentioned advantageous effect when the angle θ shown in FIG. 10 is about 90 to 150 degrees, preferably 90 to 120 degrees, and more preferably 90 to 100 degrees.

It is ideal that all the extraction lines 50 in the peripheral sealing region 30 have two flexure parts, but in some wiring design, it can be difficult to provide the two flexure parts for all the extraction lines 50. Even such cases where some extraction lines 50 cannot have two flexure parts, the above-stated advantageous effect can be obtained at a certain level. In other words, the generation or development of the void 60 and the crack in the inorganic passivation film is a matter of probability, therefore it is possible to reduce the possibility of the water permeation even when some extraction lines 50 do not have the two flexure parts.

In the above description, the inorganic passivation film which is made of SiN or the like is formed by the low-temperature CVD. However, the features described in the first and second embodiments can exert the above-mentioned advantageous effects against the deterioration of the organic El layer due to water even when the inorganic passivation film is fabricated by sputtering.

What is claimed is:

1. An organic electro-luminescence (EL) display device, comprising:
a pixel having an organic EL layer that is disposed between a lower electrode and an upper electrode, and a thin film transistor (TFT), the pixel being arranged in matrix;
a display region in which a wiring line coupled to the pixel is formed;
a peripheral sealing region provided in a periphery of the display region;
a terminal part; and
an extraction line coupling the wiring line and the terminal part,
wherein the extraction line is directly covered with an inorganic film in the peripheral sealing region, and
the extraction line has two flexure parts in the peripheral sealing region.

2. The organic EL display device according to claim 1, wherein the flexure parts are bent at 90 to 150 degrees.

3. The organic EL display device according to claim 1, wherein the flexure parts are bent at 90 to 120 degrees.

4. The organic EL display device according to claim 1, wherein the flexure parts are bent at 90 degrees.

5. An organic EL display device, comprising:
a pixel having an organic EL layer that is disposed between a lower electrode and an upper electrode, and a TFT, the pixel being arranged in matrix;
a display region in which a wiring line coupled to the pixel is formed;
a peripheral sealing region provided in a periphery of the display region;
a terminal part; and
an extraction line coupling the wiring line and the terminal part,
wherein the extraction line is directly covered with an inorganic film in the peripheral sealing region, and
the extraction line has a first flexure part and a second flexure part in the peripheral sealing region, and an angle of the first flexure part is different from an angle of the second flexure part.

6. An organic EL display device, comprising:
a pixel having an organic EL layer that is disposed between a lower electrode and an upper electrode, and a TFT, the pixel being arranged in matrix;
a display region in which a plurality of wiring lines coupled to a plurality of the pixels are formed;
a peripheral sealing region provided in a periphery of the display region;
a plurality of terminal parts; and
a plurality of extraction lines coupling the plurality of the wiring lines and the plurality of the terminal parts,
wherein the plurality of the extraction lines are directly covered with an inorganic film in the peripheral sealing region, and
each of the extraction lines has two flexure parts in the peripheral sealing region, and angles of the flexure parts of the plurality of the extraction lines are different from each other.

7. An organic EL display device, comprising:
a pixel having an organic EL layer that is disposed between a lower electrode and an upper electrode, and a TFT, the pixel being arranged in matrix;
a display region in which a wiring line coupled to the pixel is formed;
a peripheral sealing region provided in a periphery of the display region;
a terminal part; and
an extraction line coupling the wiring line and the terminal part,
wherein the peripheral sealing region has a first side that is adjacent to an area where the terminal part is formed, and a second side, a width of the first side being larger than a width of the second side,
the extraction line is directly covered with an inorganic film on the first side of the peripheral sealing region, and
the extraction line has two flexure parts on the first side of the peripheral sealing region.

8. The organic EL display device according to claim 7, wherein the width of the first side of the peripheral sealing region is ten times or more larger than the width of the second side of the peripheral sealing region.
